(19) United States
(12) Patent Application Publication
(10) Pub. No.: US 2026/0240177 A1
(43) Pub. Date: Aug. 20, 2026

(54) METHOD AND APPARATUS FOR PORTION CUTTING OF MEAT ITEMS

(71) Applicant: MAREL A/S, Aarhus N (DK)

(72) Inventors: Morten DALQVIST, Aarhus N (DK); Henrik KRISTIANSEN, Aarhus N (DK)

(21) Appl. No.: 18/992,926

(22) PCT Filed: Jul. 6, 2023
(86) PCT No.: PCT/EP2023/068707

§ 371 Date: Jan. 9, 2025

(30) Foreign Application Priority Data
Jul. 15, 2022 (EP) 22185125.6

(51) Int. Cl. A22C 21/00; A22C 17/00

(52) U.S. Cl. CPC A22C 21/003; A22C 17/002; A22C 17/0086

(57) ABSTRACT

An apparatus for portion cutting of meat items includes: a first shape sensor for measuring a shape of a meat item to be cut into portions, the shape defining a reference direction, a cutter for cutting the meat item into portions, a cutter feed conveyor for conveying the meat item to the cutter, the cutter feed conveyor defining a feed direction, a control module configured to compute, based on the measured shape and based on one or more predetermined cut criteria, a target orientation associated with the meat item, the target orientation being indicative of a target angle between the reference direction and the feed direction, and an item positioner configured to position the meat item on the cutter feed conveyor at the computed target orientation.

### TECHNICAL FIELD

The present invention relates to a method and an apparatus for portion cutting of meat items.

### BACKGROUND

Automatic portion-cutting machines for cutting meat items according to some predetermined criteria are known in the art.

U.S. Pat. No. 4,557,019 discloses an automatic portion-cutting machine, which measures the shape of a fish fillet, calculates its corresponding volume and weight, and cuts the fillet to create portions of a predetermined size. To this end, fish fillets are advanced along a conveyor to allow these operations to take place. An optical monitoring station along the conveyor sends data relating to the shape of the fillet to a processing unit which calculates the weight of the fillet and actuates a cutting unit to cut the fillet at locations corresponding to the portion size desired.

The incoming meat items, e.g. fillet or other pieces of poultry, in particular chicken, quail, duck, goose, or turkey, are often not uniformly shaped. It thus remains desirable to provide a method and apparatus for portion cutting of meat items that allow the cutting of portions that fulfil predetermined criteria. In particular, it is desirable to provide a method and apparatus for portion cutting of meat items into smaller pieces having predetermined size/shape and/or weight, e.g. strips of meat having a predetermined length and/or weight, burger fillings having a predetermined size, shape and/or weight, etc.

It is further desirable to provide a method and apparatus for portion cutting of meat items that utilizes a high fraction of the incoming meat items.

It is further desirable to provide a method and apparatus for portion cutting of meat items that is efficient and provides a high throughput.

It is further desirable to provide a method and apparatus for portion cutting of meat items that is cost efficient to manufacture and/or operate.

It is further desirable to provide a method and apparatus for portion cutting of meat items where the cutting may take the meat fiber direction of the items into account.

### SUMMARY

In general, at least some embodiments of the method and apparatus disclosed herein seek to mitigate, alleviate or eliminate one or more of the above-mentioned disadvantages and/or other disadvantages of the prior art, or to at least serve as an alternative to prior art solutions.

According to one aspect, disclosed herein are embodiments of an apparatus for portion cutting of meat items, such as pieces of poultry, e.g. chicken, quail or turkey. The meat items may be boneless pieces of meat, e.g. fillets of chicken breast. The pieces of meat, e.g. the fillets of chicken breast may e.g. be frozen or non-frozen.

Various embodiments of the apparatus include:
a first shape sensor for measuring the shape of a meat item to be cut into portions, the shape defining a reference direction, e.g. a direction of elongation of the measured shape or a principle direction of the measured shape, such as a direction of minimum moment of inertia of the measured shape,
a cutter for cutting the meat item into portions,
a cutter feed conveyor for conveying the meat item to be portion-cut to the cutter, the cutter feed conveyor defining a feed direction relative to a cutting direction of the cutter,
a control module configured to compute, based on the measured shape and based on one or more predetermined cut criteria, a target orientation associated with the meat item, in particular a target orientation indicative of a target angle between the reference direction and the feed direction, and
an item positioner configured to position the meat item on the cutter feed conveyor at the computed target orientation.

The control module may compute a target orientation for each individual meat item to be cut and the item positioner may orient all meat items, which are to be cut, according to their respective, individually computed target orientation. The target orientation defines how a reference direction, in particular an axis of minimum momentum of inertia, is to be oriented relative to the feed direction of the cutter feed conveyor, i.e. the meat items can individually be placed with their respective reference directions oriented differently from other meat items. The cutter may thus cut all meat items at a predetermined, in particular fixed, orientation relative to the feed direction while still allowing the individual items to be individually cut at differently oriented cut lines relative to their respective shapes. Accordingly, the portion cutting of the meat items can be individually controlled so as to fulfill one or more predetermined cut criteria, as the target angle is computed individually, rather than aligning the reference direction of each meat item to the feed direction in a predetermined fixed relationship. Moreover, the individual control of the cutting orientation can be achieved without the need for the cutter to include any complex mechanism for re-orienting the cut orientation relative to the feed direction.

The reference direction of the measured shape may be defined in different ways, e.g. a direction of longest or shortest linear extent of the meat item, or as a principle direction, in particular an axis of minimum or maximum moment of inertia associated with the measured shape.

Many meat items, in particular meat cuts such as breasts, legs, etc. of poultry or from other animals are chiral, i.e. they may be a right-handed or left-handed meat item. It is often desirable to align the cutting direction in dependence of the handedness of the individual meat item, in particular as the direction of muscle fibers relative to the shape of the item may be different for left- and right-handed items. Accordingly, in some embodiments, the control module is configured to identify, in particular based on the measured shape and/or based on other sensed data, the handedness of the meat item and to compute the target orientation further based on the identified handedness. Examples of other sensed data may include a captured image of the meat item or other suitable sensor data.

More generally, according to another aspect disclosed herein, an apparatus for cutting and/or otherwise processing chiral meat items comprises:
a sensor for obtaining sensor data associated with a chiral meat item to be cut or otherwise processed,
a control module configured to determine, based on the obtained sensor data, a handedness of the meat item,
an item manipulator configured to selectively manipulate the meat item in dependence on the determined handedness.

The item manipulator may be an item positioner as described herein, or it may be an item redirector for directing the meat items towards different destinations, e.g. onto different conveyors, containers or the like. Yet further examples of item manipulators may be a cutting machine, a packaging machine or any other machine manipulating the meat items.

The sensor data may include shape data indicative of a measured shape of the item as described herein, other examples include an image captured by a camera or other image capturing device, another type of vision or optical measurement device, and/or the like.

The handedness of a meat item can be detected in a variety of ways, e.g. using image processing techniques, color detection, or other optical sensing technology. In particular, in some embodiments the determination of the handedness is based on the measured shape in combination with a detection of a predetermined feature, in particular a visually recognizable anatomical feature, of the meat item. The inventors have found that detection of the handedness based on a combination with a detection of a predetermined feature, in particular a visually recognizable anatomical feature, of the meat item provides a reliable detection of the handedness. For example, the process may recognize a predetermined feature, in particular an anatomical feature, of the meat item and a reference vector associated with the meat item, in particular associated with a measured shape of the meat item. The handedness may then be determined from the position of the recognized feature relative to the reference vector. The reference vector may be defined in a variety of ways. For example, the reference vector may be defined as a vector along an axis of minimum moment of inertia of a measured shape of the meat item and pointing towards a point on a contour of the measured shape having the shortest distance from a center of mass of the measured shape. An alternative process may be implemented by a machine-learning algorithm, e.g. a convolutional network, which may receive a captured image of the meat item or a representation of the measured shape and be trained to output the handedness of the meat item, i.e. whether it originates from the left or right side of an animal.

In some embodiments, the apparatus may be configured to identify a predominant muscle fiber direction of the meat item and to compute the target orientation further based on the identified muscle fiber direction. This determination may e.g. be based on the handedness of the item and/or on a captured image having a sufficiently high resolution to detect muscle fiber direction, and/or in another suitable manner.

The item positioner may be any suitable device for selectively positioning and/or orienting meat items, e.g. by means of conveyor parts moving at different speeds and/or by means of one or more suitable actuators, and/or the like. In some embodiments, the item positioner is, or includes, a robotic manipulator, in particular a robotic manipulator operable to move a meat item in multiple degrees of freedom, preferably six degrees of freedom. In some embodiments, the robotic manipulator is a pick-and-place robot, such as a delta robot. The pick-and-place robot may have a gripper, in particular an elongated gripper, operable to grip a meat item with the reference direction of the measured shape of the meat item being aligned with a reference axis of the gripper, in particular with an axis of elongation of the gripper. Accordingly, the meat items may be placed with the reference direction accurately aligned with the computed target orientation. Moreover, in some embodiments, the meat items may be positioned with a suitable spacing, e.g. with a predetermined minimum spacing, between different items. Alternatively or additionally, the items may be fed into one, two or even more separate flows, such as separate single files, of items so as to allow concurrent cutting of multiple meat items.

In some embodiments, the item positioner is configured to position the meat item at a placement location on the cutter feed conveyor, e.g. at an inlet end of the cutter feed conveyor. Moreover, in some embodiments, the cutter defines a cutting location relative to the cutter feed conveyor, wherein the cutter feed conveyor is uninterrupted and/or extends along a straight line between the placement location and the cutting location. Accordingly, the risk of the meat item being inadvertently re-oriented during transportation, e.g. at transitions from one conveyor belt to another and/or at turns of the conveyor, from the item positioner and the cutter is reduced. The cutter feed conveyor may be a conveyor separate from the cutter and/or separate from the item positioner, or it may be an integrated part of the cutter and/or item positioner.

The apparatus may comprise a feed conveyor for feeding incoming meat items to the first shape sensor and the item positioner.

In some embodiments the feed conveyor and the cutter feed conveyor are implemented as a combined conveyor, where the feed conveyor is formed by an upstream portion of the combined conveyor and the cutter feed conveyor is formed by a downstream portion of the combined conveyor. The item positioner may thus re-orientate the meat item on said combined conveyor being the feed conveyor at an upstream location and the cutter feed conveyor at a downstream location.

In some embodiments, the apparatus comprises a separate feed conveyor configured for feeding the meat item to the item positioner, in particular the pick-and-place robot. The item positioner may thus be configured to transfer the meat item from the feed conveyor to the cutter feed conveyor. In particular, the pick-and-place robot may be configured to pick the meat item from the feed conveyor and to place the meat item onto the cutter feed conveyor. Accordingly, the speeds of the cutter feed conveyor and of the feed conveyor may be adjusted independently. This may be particularly useful when the item positioner is configured to receive the items from a single file of items and distribute the items to two or more parallel files, or vice versa.

In some embodiments, the cutter feed conveyor and the feed conveyor define a reject gap between them, the reject gap being configured for receiving any meat item being conveyed by the feed conveyor and not picked up by the pick-and-place robot. Accordingly, items that are to be rejected, e.g. based on the measured shape, can simply fall off the outlet end of the feed conveyor without taking up operational capacity of the item positioner. The rejected items thus do not take up capacity of, or even interfere with, the subsequent portion cutting and, optionally, subsequent sorting of cut portions.

The first shape sensor may use any sensing technology suitable for sensing the shape of the meat item. Examples of suitable shape sensors include an optical sensor, e.g. a laser scanner, a camera or other image capturing device, an x-ray device and/or the like, or a combination thereof. The first shape sensor may provide shape data representing, or otherwise indicative of, the measured shape. The measured shape may be represented in a variety of formats, e.g. as a 2D captured image or as a detected contour of the meat item when viewed from a predetermined viewing direction, e.g. a top view or otherwise from a viewpoint facing a supporting surface of the conveyor on which the meat items rest while being conveyed. The contour may e.g. be represented as a sequence of points or as another representation of the contour. Alternatively or additionally, the shape data may be indicative of a 3D shape of the meat item. The shape data may further comprise additional information pertaining to the measured shape, e.g. data indicative of at least one reference direction of the shape, e.g. an axis of minimum moment of inertia and/or an axis of maximum moment of inertia. It will be appreciated that such additional information may be computed and output by the first shape sensor, e.g. using image processing or other data processing techniques known as such in the art. Alternatively, the reference direction of the measured shape may be determined by the control module from the received shape data.

The information about the measured shape from the first shape sensor and/or processed shape data created by the control module based on the measured shape, may be forwarded to a cutter control module which controls operation of the cutter, in particular the timing of the individual cuts to be performed when the meat item travels through the cutter.

Alternatively or additionally, the apparatus may comprise a second shape sensor configured to measure the shape of the meat item after having been placed on the cutter feed conveyor by the item positioner, thereby allowing an accurate determination of the shape of the meat item after it has been repositioned by the item positioner. The second shape sensor may use the same shape sensing technology as the first shape sensor or a different shape sensing technology. As in the case of the first sensor, suitable shape sensing technologies for use by the second shape sensor include optical shape sensors, such as laser scanners, digital cameras, etc. or combinations thereof. The second shape sensor may determine a 2D shape or a 3D shape of the meat items. A determination of the 3D shape allows for a more accurate estimate of the weight of the meat item and a more accurate control of the cutter, e.g. when portions of predetermined weight are desired. The second shape sensor may be integrated into the cutter or be implemented as a separate device positioned upstream from the cutter and downstream from the item positioner. The cutter may be a portion cutter or another suitable meat cutting device for cutting the meat item into two or more smaller pieces, also referred to as portions. In some embodiments, the cutter is a portion cutter known as such in the art, e.g. a portion cutter as described in WO 2005/079588 or a portion cutter of type I-Cut 122 available from Marel A/S, Denmark. The cutter may have a knife or other cutting element operable to cut through the meat item while passing through the cutter. Preferably, the cutter cuts the meat item while the meat item is in motion, i.e. without the item having to rest relative to the cutter. The cutter may be operable to perform multiple cuts, e.g. parallel cuts, through the meat item resulting in multiple portions, such as three, four or more portions, cut from each meat item, e.g. so as to cut slices or strips of meat. The, or each, cut may be performed in a portion cutting plane which may be located across the feed direction of the meat items. The portion cutting plane may be orthogonal to, or inclined relative to, a support surface of the cutter feed conveyor. For example, the portion cutting plane may be oriented at an angle between 45° and 90° relative to the support surface of the cutter feed conveyor. In some embodiments, the orientation of the portion cutting plane is fixed relative to the feed direction during the cutting of each item or even fixed for respective items to be cut.

In some embodiments, the apparatus further comprises a further cutting device or a deforming device. In some embodiments, the further cutting device or deforming device is positioned upstream from the first shape sensor. The further cutting device or deforming device may be configured to provide meat items having a uniform thickness (height). To this end, the further cutting device may be configured to cut the meat item along a second cutting plane, different from the portion cutting plane, e.g. a cutting plane substantially parallel with the feed direction. The further cutting device may be operable to cut the incoming meat item to a desired, e.g. predetermined or adaptively determined, thickness (height), thereby facilitating subsequent portion cutting to portions having a predetermined shape and/or size, such as predetermined weight. Examples of a deforming device include a flattener. In some embodiments, the further cutting device or deforming device is positioned downstream of the cutter. Accordingly, the further cutting device of the deforming device may be configured to further cut or deform one or more of the cut portions produced by the cutter, e.g. to flatten the cut portions or to cut the cut portions along a second cutting plane, different from the portion cutting plane, e.g. a cutting plane substantially parallel with the feed direction. The further cutting device may be operable to cut one or more of the cut portions to a desired, e.g. predetermined or adaptively determined, thickness (height).

In some embodiments, the apparatus comprises a cutter control module configured to control the cutter to cut the meat item based on a measured shape of the meat item, in particular the measured shape as measured by the first shape sensor, and/or a measured shape as measured by the second shape sensor after the meat item has been placed by the item positioner on the cutter feed conveyor. The cutter control module may be implemented by a suitable control module or by another suitable processing unit, e.g. by the same control module that also performs the computation of the target orientation, or by a separate control module or other processing unit, e.g. by a control module integrated into the cutter.

In some embodiments, the control module performing the computation of the target orientation is further configured to receive feedback input from the cutter and/or from a second shape sensor, the second shape sensor being configured to measure the shape of the meat item after the meat item has been placed by the item positioner on the cutter feed conveyor. The control module may thus be configured to compute the target orientation associated with a current meat item further based on the received feedback input from the cutter and/or the second shape sensor, the feedback input being associated with one or more previously processed meat items. For example, such feedback information may be used by the control module to adjust the computed target position for detected misalignments of the item positioner or of the cutter feed conveyor relative to the cutter, or other angle offsets detected by the second shape sensor or the cutter. Such angle offsets may e.g. originate from any misalignment or angle offset of the first shape sensor.

In some embodiments, the apparatus further comprises an item quality sensor configured to detect one or more quality parameters of the meat item. Examples of item quality sensors include an x-ray system configured to detect bones and/or foreign objects, a vision system or color detector configured to detect discoloring and/or other quality-affecting parameters, and/or the like. The item quality sensor may be separate from and/or partly or completely be integrated into the first shape sensor. The item quality sensor may be positioned upstream of the item positioner, such as upstream from the first shape sensor. The control module controlling the item positioner may receive input from the quality sensor and be configured to reject selected items responsive to the input received from the item quality sensor. Rejected items may be removed from the flow of meat items to be cut in a suitable manner. For example, rejected meat items may be positioned by the item positioner or by another reject device to a reject location, or they may be caused to fall through a reject gap as described herein or they may be removed from the flow of meat items prior to reaching the item positioner, e.g. prior to reaching the first shape sensor. At least some rejected items, such as selected rejected items, may be led to another process, e.g. to a trimming process or another process for making the initially rejected items suitable for portion cutting. The processed items may then be recirculated into the input flow to the apparatus disclosed herein.

The one or more predetermined cut criteria on which the computation of the target orientation is based may define a target property or a target range of a property of the cut portions into which the cutter cuts the meat item, thus allowing the cutter to cut the meat item according to a predetermined specification for the cut portions. In particular, the one or more predetermined cut criteria may define one or more target ranges of the size and/or shape of the cut portions of meat. The one or more ranges defining the size of the cut portions may define a target range for the weight or volume of the cut portions and/or a target range for a linear dimension, e.g. for the length of a strip of meat, and/or target ranges for respective linear dimensions, e.g. for the length and width of a portion of meat. Examples of criteria defining target shapes, or ranges therefore, may define a length-to-width ratio or another parameter indicative of the shape of the cut portions. In particular, the predetermined cut criteria may be a combination of length and weight of strips cut from a meat item.

In some embodiments, the one or more predetermined cut criteria comprise an optimization criterion to maximize a degree of compliance of the cut portions with one or more target properties or target ranges of one or more target properties, such as with one or more target sizes and/or shapes. Accordingly, the optimization criterion may maximize the amount of cut portions of meat having a size and/or shape complying with one or more target sizes and/or target shapes. Maximizing the amount of cut portions of meat having a size and/or shape complying with one or more target sizes and/or target shapes may comprise maximizing the number of cut portions resulting from a meat item that comply with said one or more target sizes and/or target shapes. Other measures for measuring the amount of cut portions may include the fraction of the weight or volume of the meat item that result in cut portions complying with said one or more target sizes and/or target shapes.

To this end, a degree of compliance with one or more target sizes and/or target shapes may be determined as the size and/or shape of the cut portions falling within one or more target ranges. Alternatively, a degree of compliance with the one or more target sizes and/or target shapes may be determined as a deviation, optionally a weighted deviation, from a target size or shape or from a target range of sizes and/or shapes. For example, the optimization criteria may minimize an accumulated, optionally weighted, deviation of the cut portions from a predetermined target size/or target shape or from a target range of sizes and/or shapes. For instance, cut portions being much larger than the target size may be weighted with a larger penalty factor than items that are only slightly larger or smaller than the target range. In particular, when cutting irregularly shaped meat items into strips, the number of strips resulting from a particular meat item may depend on the angle, relative to a reference direction of the meat item, at which the meat item is cut. When the reference direction is an axis of minimum momentum of inertia, a cut orthogonally to the reference direction will generally result in shorter strips than a cut aligned with the reference direction. Accordingly, by appropriately orienting the meat item relative to the cutting plane, the number of strips having a predetermined length, or range of lengths, that can be cut from the particular meat item can be optimized. Generally, when the cut direction is fixed or otherwise defined relative to the feed direction along which the meat items are conveyed to the cutter, the cut direction can be optimized by suitably orienting the meat items relative to the feed direction.

The present disclosure relates to different aspects including the apparatus described above and in the following corresponding systems, methods, and/or products, each yielding one or more of the benefits and advantages described in connection with one or more of the other aspects, and each having one or more embodiments corresponding to the embodiments described in connection with one or more of the other aspects and/or disclosed in the appended claims.

In particular, according to one aspect, disclosed herein are embodiments of a computer-implemented method for controlling portion cutting of meat items, wherein the method comprises:
receiving shape data indicative of a measured shape of a meat item to be cut into portions, the shape defining a reference direction,
computing, based on the measured shape and based on one or more predetermined cut criteria, a target orientation associated with the meat item, the target orientation being indicative of a target angle between the reference direction and a feed direction for feeding the meat item to a cutter, and
outputting the target orientation for controlling an item positioner to position the meat item at the computed target orientation.

Another aspect disclosed herein relates to embodiments of a computer program configured to cause a data processing system to perform the acts of the computer-implemented method described above and in the following. A computer program may comprise program code means adapted to cause a data processing system to perform the acts of the computer-implemented method disclosed above and in the following when the program code means are executed on the data processing system. The computer program may be stored on a computer-readable storage medium, in particular a non-transient storage medium, or embodied as a data signal. The non-transient storage medium may comprise any suitable circuitry or device for storing data, such as a RAM, a ROM, an EPROM, EEPROM, flash memory, magnetic or optical storage device, such as a CD ROM, a DVD, a hard disk, and/or the like.

Yet another aspect disclosed herein relates to a data processing system configured to perform the acts of an embodiment of the computer-method described herein. To this end, the data processing system may have stored thereon program code configured, when executed by the data processing system, to cause the data processing system to perform the acts of the computer-implemented method described herein. In some embodiments, the data processing system may be implemented as, or comprised in, a control module or other processing unit of the apparatus for portion cutting described herein, e.g. a control module of one of the components, e.g. of the item positioner, of the apparatus disclosed herein. The data processing system may include a memory for storing a suitable computer program and for storing the cut criteria.

The data processing system may be implemented as a control module configured to control operation of at least a part of the portion-cutting apparatus disclosed herein. The control module may e.g. be configured to control operation of the item positioner and/or of the cutter. In some embodiments the item positioner and the cutter may be controlled by the same control module while, in other embodiments the item positioner and the cutter are controlled by respective control modules, which may or may not be communicatively coupled to each other.

Generally, a data processing system and/or a control module may comprise a suitably programmed or otherwise configured processing unit, e.g. a microprocessor. A data processing system and/or a control module may be implemented by a single processing unit or it may be distributed across multiple processing units.

According to yet another aspect, disclosed herein are embodiments of a method for portion cutting meat items, wherein the method comprises:
measuring a shape of a meat item to be cut into portions, the shape defining a reference direction,
computing, based on the measured shape and based on one or more predetermined cut criteria, a target orientation associated with the meat item, the target orientation being indicative of a target angle between the reference direction and a feed direction for transporting the meat item to a cutter;
advancing the meat item along the feed direction with the meat item oriented at the computed target orientation relative to the feed direction,
cutting the meat item into portions.

In particular, the process may comprise orienting the meat item at the computed target orientation relative to the feed direction, e.g. by picking up the meat item and by placing the meat item on a conveyor at the computed target orientation relative to the feed direction of the conveyor.

### BRIEF DESCRIPTION OF THE DRAWINGS

The above and other aspects will be apparent and elucidated from the embodiments described in the following with reference to the drawing in which:

FIG. 1 schematically illustrates an embodiment of an apparatus for portion cutting of meat items.

FIG. 2 schematically illustrates a flow diagram of a method for portion cutting of meat items.

FIGS. 3A-B illustrate an embodiment of the computation of a target orientation.

FIGS. 4 through 7 schematically illustrate further embodiments of an apparatus for portion cutting of meat items.

FIGS. 8A-B illustrate yet another embodiment of an apparatus for portion cutting of meat items.

FIGS. 9A-B illustrate a process for computing the target orientation for chiral meat items.

FIGS. 10A-B illustrate an example of the distributions of strip lengths cut from fillets of chicken breasts.

FIG. 11 illustrates another example of a process for computing the target orientation for meat items.

### DETAILED DESCRIPTION

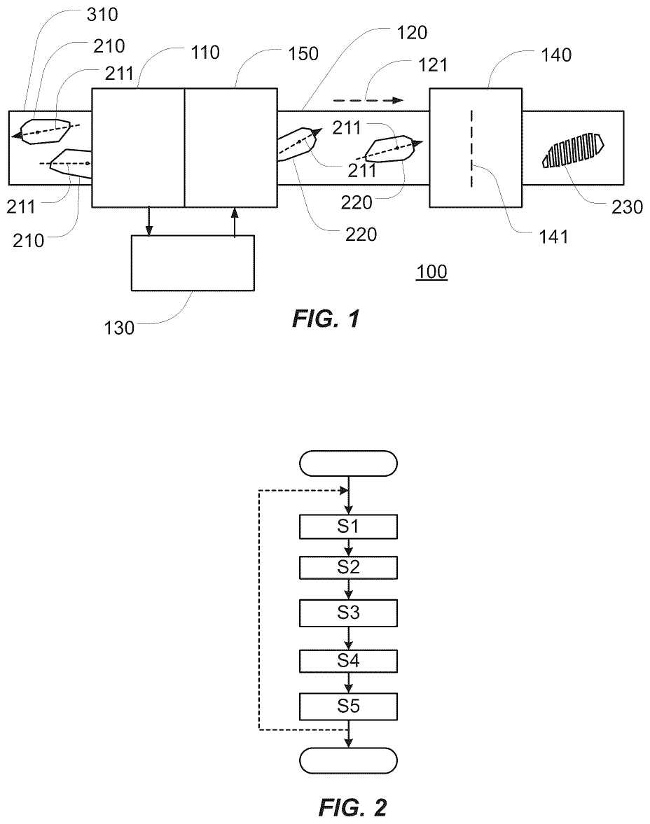

FIG. 1 schematically illustrates an embodiment of an apparatus for portion cutting of meat items, such as breast fillets of poultry, e.g. chicken. The apparatus, generally designated by reference numeral 100, comprises a first shape sensor 110, a cutter feed conveyor 120, a control module 130, a portion cutter 140 and an item positioner 150.

The cutter feed conveyor 120 feeds meat items 220 to be cut into smaller portions to the portion cutter 140. In particular, the cutter feed conveyor 120 feeds the meat items 220 to the portion cutter 140 along a feed direction illustrated by dashed arrow 121. The portion cutter 140 cuts the meat items 220 into smaller portions 230, e.g. into strips, burger fillings, etc. To this end, the portion cutter 140 may perform one or multiple cuts through each meat item 220 to be cut. The portion cutter 140 may perform the one or more cuts in a cutting plane suitably oriented relative to the feed direction 121, e.g. across the feed direction, such as orthogonal or slightly inclined relative to the feed direction. In FIG. 1, the cutting plane is schematically illustrated by dashed line 141. The portion cutter 140 may be a portion cutter known as such in the art.

Before being fed into the portion cutter, the meat items are measured and selectively oriented relative to the feed direction 121 of the cutter feed conveyor 120.

To this end, the incoming meat items 210 may be received from bulk or from a preceding process, e.g. from another cutting operation. The incoming meat items 210 may be predetermined cuts of an animal, e.g. breast fillets of poultry such as chicken, other fillets etc. In some embodiments, the incoming items 210 are boneless meat items, in particular frozen or non-frozen boneless meat items. The incoming meat items 210 may be conveyed to the first shape sensor 110 by a feed conveyor 310. The feed conveyor 310 and the cutter feed conveyor 120 may be implemented as a single conveyor. Alternatively, the feed conveyor 310 may be different from the cutter feed conveyor 120, as will be described in more detail below.

The first shape sensor 110 measures the shape of each of the incoming meat items 210 and forwards shape data indicative of the measured shapes to the control module 130. The incoming meat items 210 may be arbitrarily positioned and/or oriented on the feed conveyor 310. In some embodiments, the incoming meat items 210 may be pre-sorted and/or at least partly arranged in a predetermined order, e.g. as a single file or two parallel files, and/or the like.

The first shape sensor 110 may use any suitable sensing technology for detecting the shape of the incoming meat items 210. In particular, the first shape sensor 110 may be an optical sensor, e.g. a laser scanner, a digital camera, etc. or a combination of multiple sensors e.g. a laser scanner and a digital camera. The shape data provided by the first shape sensor 110 to the control module 130 may include laser scanning profiles, one or more digital images and other raw sensor data for further processing by the control module 130. Alternatively or additionally, the shape data provided by the first shape sensor 110 to the control module 130 may include processed data. The processing may include one or more initial signal processing steps such as noise reduction, filtering etc. and/or more advanced signal or data processing such as image or signal analysis for object recognition and/or shape analysis. To this end, the first shape sensor 110 may perform a processing of the sensor data, e.g. to identify the incoming meat items and to create a representation of the measured shape. To this end, the first shape sensor 110 may analyze scan lines of a laser scanner, where the scan lines represent respective height profiles of the scanned meat item. The first shape sensor 110 may thus detect a representation of a contour of the meat item 210 being scanned, e.g. a representation comprising a plurality of detected points along the contour of the meat item or another suitable representation. In embodiments where the first shape sensor 110 includes a digital camera or another image capture device, the first shape sensor 110 may perform image analysis to identify the shape of the meat item. It will be appreciated that the first shape sensor 110 may output a two-dimensional representation of the shape of the meat item, e.g. an image representing a top view and/or a contour of a top view of the item. Alternatively or additionally, the first shape sensor may provide a 3D representation of the shape, e.g. by a depth camera, a stereo camera, a laser scanner providing height profiles, etc. It will further be appreciated that a 2D representation, e.g. a contour of a top view of the meat item, may be obtained from such a 3D representation, e.g. by suitable projection. Alternatively or additionally to determining a representation of a contour of the meat item 210, the first shape sensor 110 may further output one or more attributes of the meat item that are derivable from the detected shape. Examples of such attributes include estimated dimensions, such as length, width, height, volume, and/or derived attributes such as an estimated weight, a center of mass and a reference direction, e.g. an axis of minimum moment of inertia, etc. The weight may e.g. be estimated from a determined volume and from a known or estimated specific weight of the meat items, and/or based on an actually weighing of the meat items. In FIG. 1, the center of mass of each meat item is schematically illustrated by a dot and a reference direction of each incoming item is illustrated by a dotted arrow 211. In the present example, the reference direction 211 is the axis of minimum moment of inertia. The axis of minimum inertia may be represented as a vector, e.g. a vector pointing away from the center of mass and towards the intersecting point between the axis of minimum moment of inertia and the contour, which is closest to the center of mass. However, it will be appreciated that, in alternative embodiments, a reference direction of a measured shape of an incoming meat item may be defined in a different manner, e.g. as a direction of the largest linear extent of the item or otherwise. Examples of shape sensors suitable for detecting the shape of a meat item and/or computing derived attributes are known as such in the art.

In some embodiments, some or all of the processing of the sensor data for computing the representation of the measured shape and/or of the derived attributes is performed by the control module 130 instead of the first shape sensor 110. Yet alternatively, the processing of the sensor data for computing the representation of the measured shape and/or of the derived attributes is partly performed by the first shape sensor 110 and partly by the control module 130.

For each of the incoming meat items 210, the control module 130 receives shape data from the first shape sensor 110 and computes, based on the measured shape and based on one or more predetermined cut criteria, a target orientation associated with the meat item 210, the target orientation being indicative of a target angle between the reference direction 211 and the feed direction 121. The cut criteria may define a target size (or other target criteria) of the cut portions into which the portion cutter cuts the meat item, e.g. a target length of the strips into which the meat item is to be cut, or the dimensions of a burger filling. The control module 130 computes the target orientation of each meat item individually, in particular such that the degree of compliance of the cut portions, cut from a particular meat item, with the target size is maximized. In this respect, the degree of compliance may be quantified as a suitable compliance function to be optimized. In one example, the compliance function may measure the fraction of the meat item that results in cut portions fulfilling the target size, e.g. which result in strips having a length within a target range. The control module may thus select the target orientation such that the compliance function is maximized. In other examples, the compliance function may be selected such that the control module may seek to minimize the compliance function. For example, in one embodiment, the compliance function may compute an accumulated degree of deviation of the cut portions from the target size. The degree of deviation may e.g. be measured as the difference of the actual size of the individual cut portions from the target size, optionally weighted by a penalty factor further penalizing undesired deviations. While the cut criteria may be determined during manufacture, commissioning or initial configuration of the apparatus, alternatively or additionally, the cut criteria may be configurable, in particular by an operator of the apparatus during normal operation of the apparatus. To this end, the control module may comprise a memory or other data storage device for storing the cut criteria. The control module may further comprise an interface for receiving cut criteria, e.g. modified cut criteria. The interface may include a communication interface for receiving modified cut criteria from a remote computer and/or a user interface, which may allow a user/operator to manually adjust the cut criteria, in particular during normal operation of the apparatus.

The control module 130 controls the item positioner 150, which may be positioned downstream of the first shape sensor 110, to position the meat items on the cutter feed conveyor 120 at their respective computed target orientations. The item positioner 150 is preferably a pick-and-place robot, such as a delta robot, which is capable of accurately orienting the individual meat items. To this end, the item positioner may comprise an elongated, rotatable gripper and the item positioner may be configured to align the axis of elongation of the gripper with the actual orientation of the reference direction 211 of each incoming meat item, grip the meat item, rotate it and place it on the cutter feed conveyor 120 with its reference direction 211 directed at the computed target angle relative to the feed direction 121 of the cutter feed conveyor 120. It will be appreciated, however, that other embodiments may include a different type of item positioner.

In the example of FIG. 1, the control module 130 is illustrated as a separate block that is communicatively connected to the first shape sensor 110 and to the item positioner 150. However, it will be appreciated that the control module 130 may be integrated into the first shape sensor 110 and/or the item positioner 150 instead. In one embodiment, the first shape sensor 110, the item positioner 150 and the control module 130 may be implemented as a single machine.

The cutter feed conveyor 120 conveys the properly oriented meat items 220 to the portion cutter 140 where they are cut into portions. In order to reduce the risk that the meat items 220 are inadvertently repositioned relative to the feed direction 121 while being conveyed between the item positioner 150 and the portion cutter 140, it may be preferable that the cutter feed conveyor 120 is a straight, uninterrupted conveyor, i.e. where the meat items do not have to travel through sharp turns or be transferred from one conveyor, e.g. from one belt, to another.

The portion cutter 140 cuts the meat items 220 along a cutting plane into portions 230 which may then be led to a further processing, such as further cutting sorting, batching, packaging and/or the like. The portion cutter 140 typically cuts each meat item multiple times so as to obtain cut portions of a desired target size (e.g. cut length). The multiple cuts may be substantially parallel, e.g. along the same or at least parallel cutting planes 141 relative to the feed direction, thus resulting in cut portions 230 in the form of strips. However, it will be appreciated that, in other embodiments, the portion cutter 140 may perform cuts in a different cut pattern, so as to obtain differently shaped portions e.g. different cut lengths. In any event, as the meat items 220 are individually oriented relative to the feed direction 121 of the cutter feed conveyor 120, the portion cutter 140 does not need to individually adjust the orientation of the cutting plane 141 or other cut pattern relative to the feed direction 121 of the cutter feed conveyor 120 between consecutive meat items 220 being cut.

The portion cutter 140 may include its own control module (not explicitly shown in FIG. 1) or it may be controlled by control module 130 or by yet another control module.

FIG. 2 schematically illustrates a flow diagram of a method for portion cutting of meat items. Examples of the method may be performed by one of the embodiments of a portion-cutting apparatus disclosed herein or otherwise.

In step S1, the process measures the shape of a meat item to be cut into portions. The shape of the meat item defines a reference direction. The process may provide shape data indicative of the measured shape to a data processing system, such as to a control module for controlling operation of an item positioner as described herein. The data processing system may thus receive the shape data and perform one or more of the following steps.

In step S2, the process computes, based on the measured shape and based on one or more predetermined cut criteria, a target orientation associated with the meat item, the target orientation being indicative of a target angle between the reference direction and a feed direction for transporting the meat item to a portion cutter.

In step S3 the process outputs the target orientation for controlling an item positioner to position the meat item at the computed target orientation.

In step S4, the process feeds the meat item to the portion cutter.

In step S5, the process cuts the meat item into portions.

The process may then return to step S1 and receive a subsequent meat item. However, it will be appreciated that multiple meat items may be processed at least partly concurrently, for example the process may already measure the shape of a subsequent meat item while a current item is being positioned and/or while a current and/or one or more previous items are being conveyed to the portion cutter and/or cut into portions.

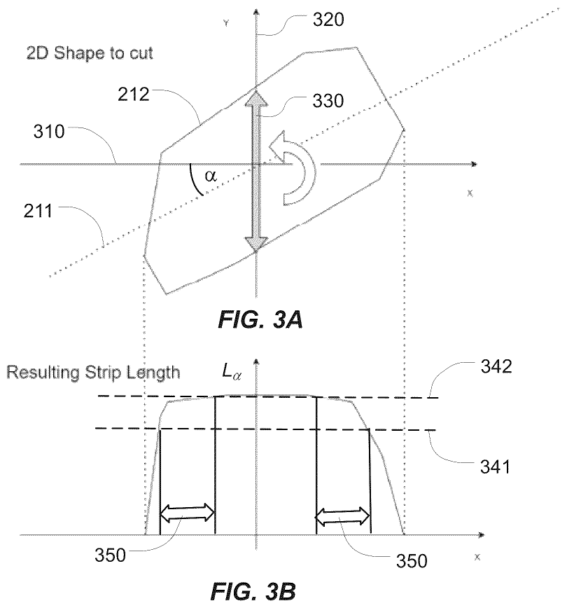

FIGS. 3A-B illustrate an embodiment of the computation of a target orientation.

FIG. 3A schematically illustrates shape data representing the measured shape of a meat item, e.g. a chicken breast fillet. In the example of FIG. 3A, the shape data represents a measured contour 212 of the meat item. The measured contour 212 may be measured by a laser scanner having scanned the meat item lying on a feed conveyor from a viewpoint above the feed conveyor, e.g. looking vertically downward. The laser scanner may provide a height profile, e.g. in the form of profile scan lines. From the profile scan lines, points on the contour of the meat item may be identified. The contour 212 may then be represented as a series of contour points, optionally linearly or otherwise interpolated. It will be appreciated that the shape of a meat item may alternatively or additionally be measured and/or represented in a different manner.

In FIG. 3A, the measured shape of the meat item is shown relative to a coordinate system where the x-axis 310 is aligned with the feed direction of the cutter feed conveyor on which the meat item is to be positioned and the y-axis 320 is aligned with the cut direction of the portion cutter.

The measured shape defines a reference direction 211 of the measured shape, e.g. the axis of minimum moment of inertia, which is defined by, and can be computed from, the measured contour 212.

When the meat item is oriented with its reference direction 211 oriented at an angle relative to the feed direction, a cut along the y-axis has a cut length La indicated by arrow 330. Cutting the item along cut lines parallel to the y-axis 320 at different positions along the x-axis 310 results in respective lengths La (x).

FIG. 3B shows an example of the cut length Lo (x) as function of x for a selected angle α. The cut length is a measure of the strip length of a narrow strip of meat cut at position x.

From the cut length, the process may determine a compliance function indicative of how well the resulting strip length complies with a target criterion for the strip length. For example, the process may determine the fraction of the entire meat item that can be cut into strips having a strip length within a target range. In FIG. 3B, an example of a target range is indicated by a minimum target length 341 and a maximum target length 342. The portion of the meat item that, when the item is oriented with its reference direction 211 at angle α relative to the feed direction, will be cut into strips within the target range, is indicated in FIG. 3B by arrows 350. As the cut length depends on α, changing the angle α also changes the resulting portion that will be cut according to the target range. Accordingly, by varying α, the portion of the meat item that will be cut into strips having a length inside the target range can be maximized.

It will be appreciated that other compliance functions may be selected. For example, the process may minimize a compliance function that measures the deviation from a predetermined target length, e.g. as

$$C ( α ) = {\int }_{{x}_{0}}^{{x}_{1}} f ( {L}_{α} ( x ) ) dx ,$$

where the integral is over the linear extent of the item along the x-axis, as designated by the interval [x₀,x₁], and where the function ƒ measures the local degree of compliance of at strip at cut position x with the target criterion.

One example of a local compliance function may be expressed as

$$f ( {L}_{α} ( x ) ) = P ( {L}_{α} ( x ) - {L}_{opt} ) \cdot {( {L}_{α} ( x ) - {L}_{opt} )}^{2} ,$$

$$or as$$

$$f ( {L}_{α} ( x ) ) = P ( {L}_{α} ( x ) - {L}_{opt} ) \cdot {\vert {L}_{α} ( x ) - {L}_{opt} \vert}^{2} ,$$

or in a similar manner, where Lₒₚₜ is a predetermined optimal target strip length and P is a penalty function which allows a customized weighting of different deviations from a target length. The process may then determine the target angle αₜ as the value of α, e.g. within a predetermined range of angles [α₀, α₁], that minimizes the corresponding compliance function

$$C ( α ) , i . e . {α}_{t} = {arg min}_{α ∈ [ {α}_{0} , {α}_{1} ]} C ( α ) .$$

Different choices of penalty functions result in different cut criteria. One example of a penalty function P(δ) as a function of the deviation of the strip length from the target strip length δ=L_{α}(x)−Lₒₚₜ may be expressed as:

$$P ( δ ) = \{ \begin{matrix}0 & if \vert δ \vert \leq D \\ {P}_{0} & if δ < - D \\ {P}_{0} + δ & if δ > D\end{matrix} ,$$

where D is a predetermined target width of a target range of acceptable strip lengths around the optimal strip length Lₒₚₜ and where P₀ₓ is a predetermined penalty factor penalizing strips that are shorter than the acceptable range of strip lengths. This example penalizes short strips by a configurable constant factor. Long strips are increasingly penalized the more they deviate from the acceptable range and always penalized more than short strips.

Another example of a penalty function may be expressed as:

$$P ( δ ) = \{ \begin{matrix}0 & if \vert δ \vert \leq D \\ {P}_{short} & if δ < - D \\ {P}_{long} & if δ > D\end{matrix} ,$$

Where Pₛₕₒᵣₜ and P_{long} are predetermined fixed penalty factors for penalizing short and long strips, respectively.

It will be appreciated that the skilled person may select other types of compliance function and/or other penalty functions to express other desired cut criteria.

It will be appreciated that other embodiments may be based on yet other compliance functions with or without penalty function.

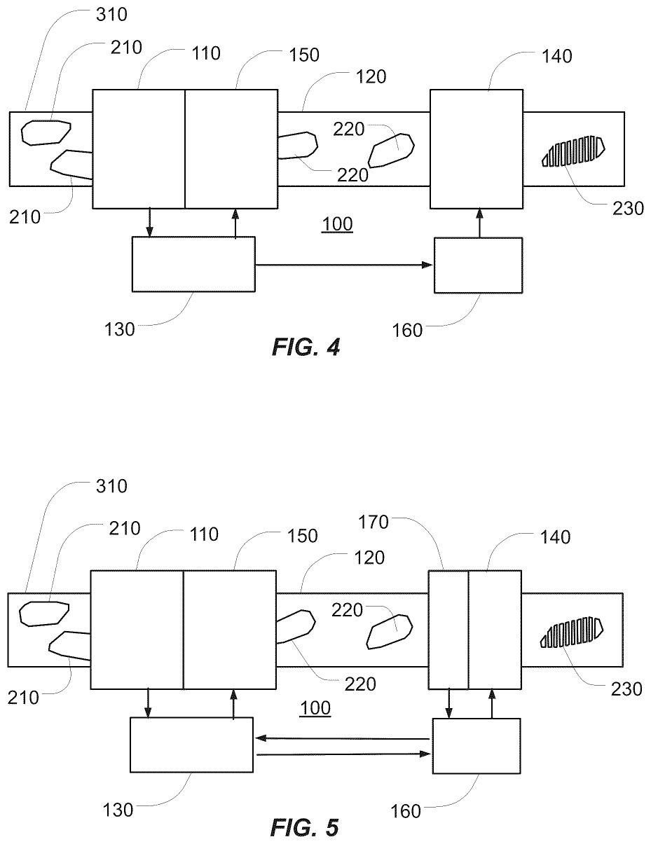

FIG. 4 schematically illustrates another embodiment of an apparatus for portion cutting of meat items. The apparatus 100 of FIG. 4 is similar to the embodiment of FIG. 1 in that it comprises a first shape sensor 110, a cutter feed conveyor 120, a control module 130, a portion cutter 140 and an item positioner 150, all as described in connection with FIG. 1.

In the embodiment of FIG. 4, the apparatus further comprises a cutter control module 160 that controls operation of the portion cutter 140. The cutter control module 160 may control operation of the knife or other cutting member of the portion cutter 140, in particular the timing as to when to perform cuts, in particular the timing relative to the arrival of the meat item 220 to be cut at the cutting location of the portion cutter 140. Moreover, it may be desirable that the cut strips all have a weight falling within a range of target weights. As the length and/or height of the strips may vary from strip to strip, it may thus be desirable to adaptively adjust the width of the strips, i.e. the distance between consecutive cuts, responsive to the measured shape. To this end, the cutter control module 160 may receive appropriate shape data and/or cutting instructions from the control module 130 and control the portion cutter in accordance therewith. Alternatively, the cutter control module 160 may receive shape data directly from the first shape sensor 110. It will further be appreciated that, in some embodiments, the control module 130 and the cutter control module 160 may even be implemented as a single control module.

FIG. 5 schematically illustrates yet another embodiment of an apparatus for portion cutting of meat items. The apparatus 100 of FIG. 5 is similar to the embodiment of FIG. 1 in that it comprises a first shape sensor 110, a cutter feed conveyor 120, a control module 130, a portion cutter 140 and an item positioner 150, all as described in connection with FIG. 1.

In the embodiment of FIG. 5, the apparatus comprises a cutter control module 160 that controls operation of the portion cutter, e.g. as described in connection with FIG. 4. To this end, in the present embodiment, the apparatus 100 comprises a second shape sensor 170, upstream of the portion cutter 140, either as a separate device or integrated into the same machine as the portion cutter 140. The second shape sensor 170 may use the same shape sensing technique as the first shape sensor 110 or a different shape sensing technique to measure the shape of the meat items 220 approaching the portion cutter 140 on the cutter feed conveyor 120, i.e. downstream from the item positioner 150. The cutter control module 160 may thus receive shape data from the second shape sensor 170 and control the portion cutter 140, in particular the timing of the individual cuts, based on the received shape data.

In the example of FIG. 5, the cutter control module 160 is illustrated as a separate block that is communicatively connected to the second shape sensor 170 and to the portion cutter 140. However, it will be appreciated that the cutter control module may be integrated into the second shape sensor 170 and/or the portion cutter 140. In one embodiment, the second shape sensor 170, the portion cutter 140 and the cutter control module 160 may be implemented as a single machine.

In some embodiments, the cutter control module 160 and the control module 130, which controls the item positioner 150, may operate independently from each other. In other embodiments, they may be communicatively coupled with each other or even be integrated into a single, combined control module. When the cutter control module 160 is communicatively coupled to the control module 130, or even integrated with it, the cutter control module 160 may, in addition to the shape data from the second shape sensor 170 receive additional shape data and/or cutting instructions from the control module 130. Alternatively or additionally, the control module 130 may receive feedback information from the cutter control module 160. In particular, the cutter control module 160 may send information about an actual orientation of the meat items 220 when they arrive at the portion cutter, thereby allowing the control module 130 to account for any misalignments or other deviations when computing target orientations of subsequent meat items 210.

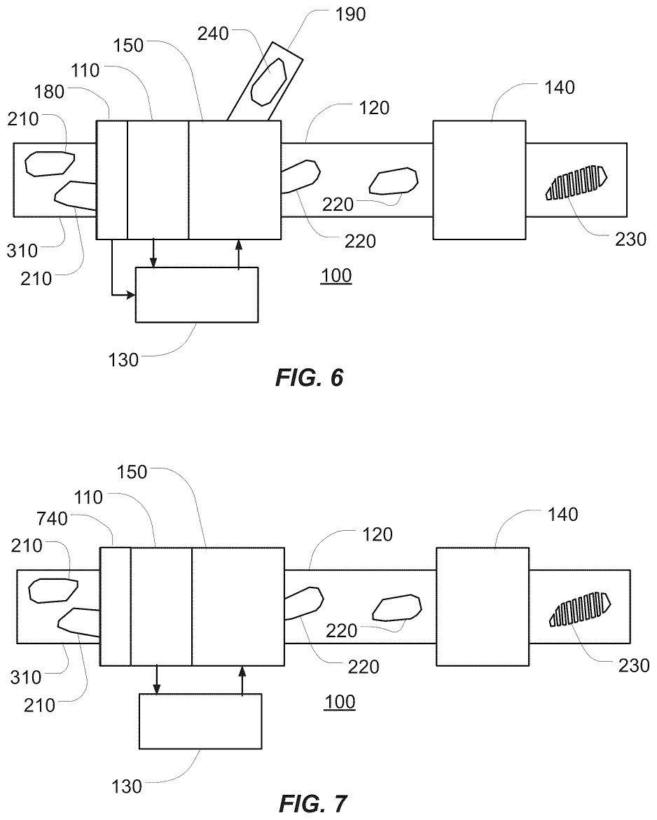

FIG. 6 schematically illustrates yet another embodiment of an apparatus for portion cutting of meat items. The apparatus 100 of FIG. 6 is similar to the embodiment of FIG. 1 in that it comprises a first shape sensor 110, a cutter feed conveyor 120, a control module 130, a portion cutter 140 and an item positioner 150, all as described in connection with FIG. 1.

In the embodiment of FIG. 6, the apparatus 100 further comprises a quality sensor 180 that is configured to obtain quality data of the incoming meat items 210. In the example of FIG. 6, the quality sensor 180 is illustrated upstream from the first shape sensor 110. Alternatively, the quality sensor 180 may be integrated into the first shape sensor 110 or positioned between the first shape sensor 110 and the item positioner 150.

The quality sensor 180 may use one or more sensors to obtain measurements suitable for assessing the quality of the incoming meat items 210. Examples of quality sensors include an x-ray sensor for detecting foreign objects and/or bones, a color camera or color sensor for detecting discoloring, blood clots, fat content, and/or the like.

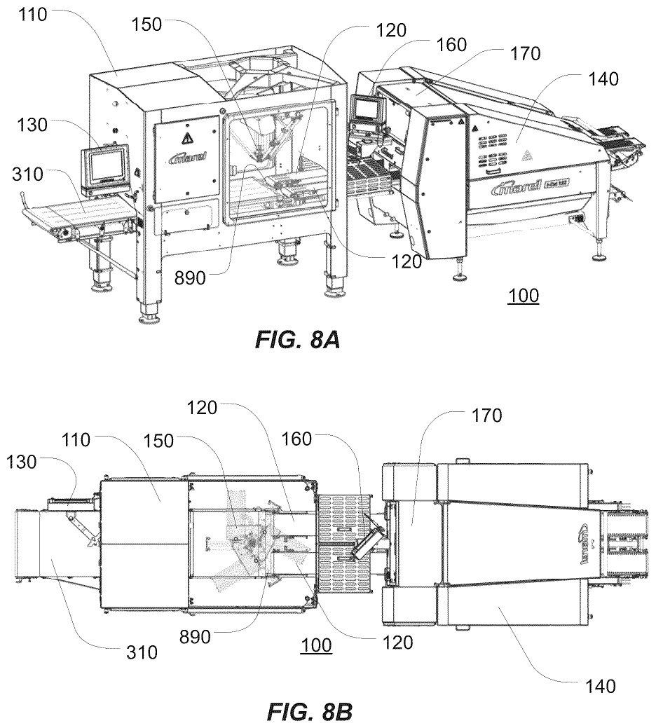

The quality sensor 180 may feed the sensed quality data to the control module 130. The control module 130 may thus control the item positioner 150 to place any identified item 240 that is not suitable for the intended use in a suitable reject location 190, e.g. a reject bin, a reject conveyor, etc. such that the rejected meat items 240 do not reach the portion cutter 140. In some embodiments, the apparatus 100 comprises a reject mechanism that does not require an active manipulation of the rejected items by the item positioner 150 or otherwise, e.g. as will be described in connection with FIGS. 8A-B below. It will be appreciated that, alternatively or additionally, the control module 130 may also cause items to be rejected based on the shape data received from the first shape sensor 110, e.g. in case of meat items having a shape or size outside predetermined specifications.

It will be appreciated that other embodiments, e.g. the embodiments of FIG. 4, 5, 7 or 8A-B, may also include a quality sensor and/or reject mechanism as described above or otherwise.

FIG. 7 schematically illustrates yet another embodiment of an apparatus for portion cutting of meat items. The apparatus 100 of FIG. 7 is similar to the embodiment of FIG. 1 in that it comprises a first shape sensor 110, a cutter feed conveyor 120, a control module 130, a portion cutter 140 and an item positioner 150, all as described in connection with FIG. 1.

In the embodiment of FIG. 7, the apparatus 100 comprises an additional cutter 740, which may be located upstream from the first shape sensor 110. The additional cutter 740 may be configured to pre-cut one or more of the incoming meat items. For example, the additional cutter 740 may cut the incoming meat items to a predetermined thickness (height), e.g. by placing a cut in a cutting plane parallel to the support surface of the feed conveyor 310. Accordingly, the subsequent portion cutting may result in portions that more accurately fulfill certain size specifications, e.g. weight specifications.

It will be appreciated that other embodiments, e.g. the embodiments of FIG. 4, 5, 6 or 8A-B, may also include an additional cutter as described above or otherwise.

FIGS. 8A-B illustrate yet another embodiment of an apparatus for portion cutting of meat items. In particular, FIG. 8A shows a three-dimensional view of the apparatus 100 while FIG. 8B shows a top view of the apparatus 100.

The apparatus 100 of FIGS. 8A-B is similar to the embodiment of FIG. 4 in that it comprises a first shape sensor 110, a cutter feed conveyor 120, a control module 130, a portion cutter 140, an item positioner 150, a feed conveyor 310, a second shape sensor 170 and a cutter control module 160, all as described above.

In this embodiment, the cutter feed conveyor 120 includes two conveyor tracks such that meat items are fed into the portion cutter 140 as two concurrent single files of items, which the portion cutter 140 is configured to process concurrently. To this end, the portion cutter may have two knives that can be controlled individually.

Moreover, in this embodiment, the item positioner 150 is a delta robot which picks up the incoming items from the feed conveyor 310 and places them on the cutter feed conveyor 120. The feed conveyor 310 and the cutter feed conveyor 120 are separate conveyors and they are arranged such that there is a gap 890 between the outlet end of the feed conveyor 310 and the inlet end of the cutter feed conveyor 120. The outlet end of the feed conveyor 310 and the inlet end of the cutter feed conveyor 120 are both arranged within the working area of the delta robot 150, so as to allow the delta robot 150 to pick up items from the outlet end of the feed conveyor 310 and to place them on the inlet end of the cutter feed conveyor 120. The gap 890 is sized and shaped so as to allow meat items that are not picked up from the feed conveyor 310 by the delta robot 150 fall over the outlet end of the feed conveyor 310 and through the gap 890.

Accordingly, an efficient reject mechanism is provided for items that are to be rejected, e.g. because their size and/or shape does not fulfil the requirements, because two items are positioned too close to each other or even on top of each other, or because an upstream quality control sensor has detected them as deviant items. In particular, the delta robot 150 does not need to use capacity on manipulating the items to be rejected, as they will simply fall through the gap 890. The same goes for items the delta robot 150 does not manage to properly orient, e.g. because too many items reach the delta robot 150 at the same time. These items also fall through the gap 890. Accordingly, all items on the cutter feed conveyor 120 are non-rejected items that are properly oriented, thereby reducing the need for sorting the resulting cut portions produced by the portion cutter 140.

It will be appreciated that other embodiments, e.g. the embodiments of FIG. 4, 5, 6 or 7, may also include two or more parallel cutter feed conveyors and/or a reject gap as described above or otherwise.

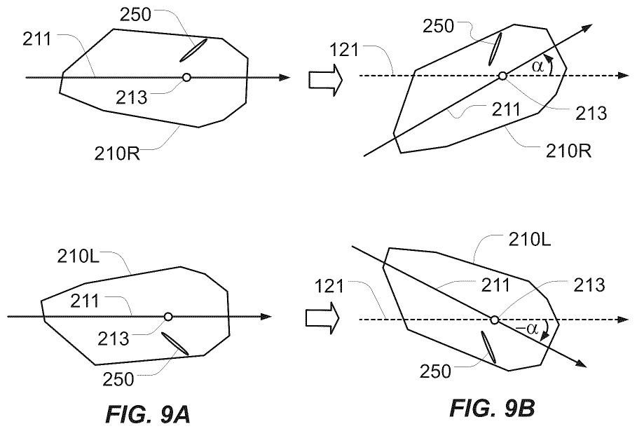

FIGS. 9A-B illustrate a process for computing the target orientation for chiral meat items.

Many meat items are chiral, i.e. they have a handedness and exist in a left-handed and right-handed version, typically dependent on which side of an animal body they originate from. In some embodiments, the preferred orientation of the chiral meat item to be cut into portions may depend on whether the meat item is a left- or right-handed item. For example, the main direction of the muscle fibres may be different for left- and right-handed meat items, respectively. It may thus be preferred that left- and right-handed meat items are processed differently. In particular, in various embodiments of the apparatus for portion cutting described herein, the preferred target orientation may depend on the muscle fibre direction, which in turn may depend on the handedness of the meat item.

Accordingly, various embodiments of the apparatus may detect the handedness of incoming chiral meat items and compute the target orientation further based on the detected handedness. Alternatively, the process may detect the muscle fibre direction in a different manner, e.g. by image processing of sufficiently high-resolution images of the incoming meat items.

The handedness of the incoming meat items may often be detected from the shape data obtained by the first shape sensor. Such detection may be based on the shape contour or on a combination of the shape contour with other input, e.g. a digital image of the meat item, a measured optical property, or the like. In particular, the process may recognize a predetermined feature of the meat item and a position of the recognized feature relative to the reference direction. This is illustrated in FIGS. 9A-B for the example of a piece of chicken breast fillet. FIG. 9A shows a left chicken breast fillet 210L and a right chicken breast fillet 210R. Chicken breast fillets have a visible tendon 250 indicating the position where the wings have been attached. The tendon 250 can be identified from image processing of a digital image of the chicken breast fillet, and may be observed as a white line. From the location of the tendon 250 relative to the principle axes of the measured shape, in particular relative to the axes of minimum and maximum momentum of inertia, respectively, the process may detect whether a particular chicken breast fillet is a left-handed or right-handed breast fillet.

The process may then determine the target angle accordingly, in particular, in some embodiments the magnitude of the angle between the reference direction 211 (e.g. the axis of minimum momentum of inertia) and the feed direction 121 of the cutter feed conveyor may be independent of the handedness of the item, but the sign of the angle may depend on the handedness, as is illustrated in FIG. 9B.

FIG. 9B shows the target orientation of the left chicken breast fillet 210L with the reference direction 211 rotated away from feed direction 121 by an angle α. FIG. 9B further illustrates the target orientation of the right chicken breast fillet 210R with the reference direction 211 rotated away from feed direction 121 in the opposite direction, i.e. by a corresponding angle −α. In this respect, the direction of the rotation may be determined by defining a leading end of the meat item, e.g. the end closest to the center of mass 213. Hence, regardless of its handedness, each meat item may be advanced with the tendon 250 being located on a trailing side of the meat item and with the end closest to the center of mass leading, and with an individually determined target angle between the feed direction and the reference direction of the meat item.

It will be appreciated that other embodiments may be based on the detection of the location of other detectable anatomical features, in particular visually detectable features.

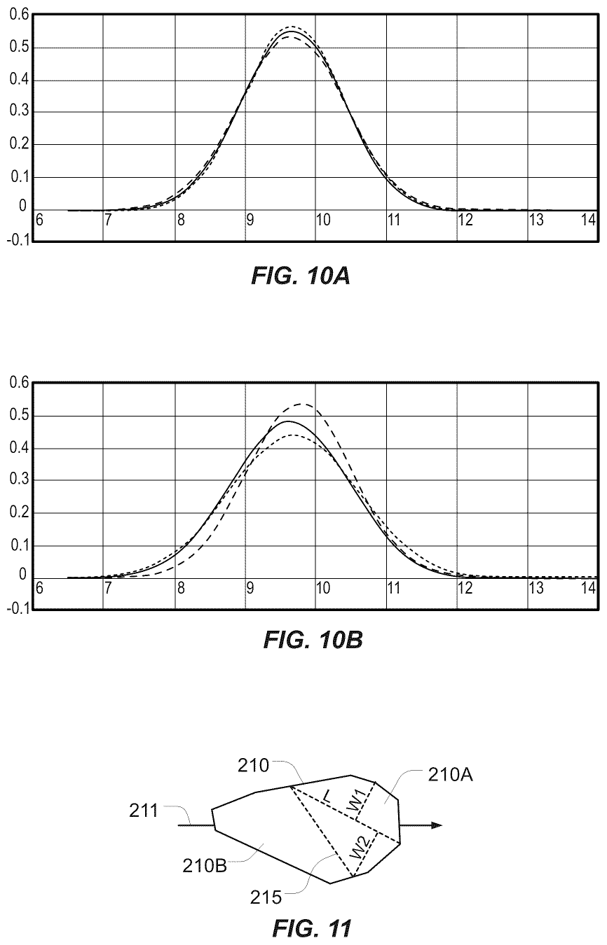

FIGS. 10A-B illustrate an example of the distributions of the lengths of strips cut from chicken breast fillets. FIG. 10A shows distributions of strip lengths obtained by the embodiment of FIGS. 8A-B, while FIG. 10B shows a comparative example where the chicken breast fillets were manually placed on the conveyor feeding into the portion cutter.

In each of FIGS. 10A-B, three distributions are shown corresponding to respective distributions during periods at the beginning, the middle and the end of a work shift. As can be seen, the distributions obtained by the embodiment of FIGS. 8A-B have a smaller standard deviation and they are uniform throughout a work shift.

As mentioned earlier, various embodiments of the apparatus and method disclosed herein may be used to cut pieces of meat, e.g. chicken breast fillets, into various types of portions, e.g. strips, burger fillings, etc. It will be appreciated that different types of portions may be associated with different cut criteria for optimizing the cut direction, e.g. expressed by a suitable compliance function and/or penalty function to express the desired cut criteria.

FIG. 11 illustrates another example of a process for computing the target orientation for meat items. In this example, the meat item is a chicken breast fillet 210, which is to be cut into a burger filling portion 210A and a remaining portion 210B. To this end, the meat item 210 is cut along a desired cutting plane 215, e.g. a substantially vertical cutting plane when the meat item is conveyed on a horizontal conveyor. The remaining portion 210B may, in some situations, be used to cut another burger filling portion. Alternatively or additionally, the remaining portion 210B may be utilized otherwise, e.g. be cut into strips or otherwise cut or processed. The further cutting of the remaining portion 210B may be performed by the same cutter or by a subsequent cutter. In some embodiments, the burger filling portion 210A may subsequently be cut along a different, e.g. horizontal, cutting plane to obtain two burger fillings. Alternatively or additionally, the burger filling portion may be flattened or otherwise processed further.

It may be desirable to determine the cutting plane 215 such that the burger filling portion 210A fulfils one or more target criteria, e.g. has a desired weight and/or desired dimensions. The desired dimensions may be expressed as a desired length L (as defined as the longest linear extend of the burger filling portion 210A) and a desired width (along a direction across the direction of the length), e.g. such that the shape and size of the burger filling corresponds to the dimensions of a burger bun in which the burger filling is to be placed. In one example, the width may be expressed as the sum of two half width W1 and W2, respectively, on opposite sides of the length axis L. When an optimal position and/or orientation of the cutting plane has been determined, the process may determine a target angle between the reference direction 211 and the feed direction of the conveyor and place the meat item on the conveyor at the thus determined target orientation as described herein.

It will be appreciated that the desired weight and the desired dimensions may be expressed as respective intervals of permitted values. Alternatively or additionally, the process may define a penalty function, e.g. by defining a deviation from a target value.

The process may thus compute the resulting length and width, and the resulting weight for multiple positions and orientations of the cutting plane 215. The position and orientation of the cutting plane may be expressed relative to a reference direction 211 and the centre of mass 213, e.g. as described for the previous embodiments. In some embodiments, the process may limit the search space, e.g. to a certain range of angles and/or positions.

Embodiments of the method described herein can be implemented by means of hardware comprising several distinct elements, and/or at least in part by means of a suitably programmed microprocessor. In the apparatus claims enumerating several means, several of these means can be embodied by one and the same element, component or item of hardware. The mere fact that certain measures are recited in mutually different dependent claims or described in different embodiments does not indicate that a combination of these measures cannot be used to advantage.

In particular, in some embodiments, some or all of the components of the apparatus, such as some or all of the shape sensor, the item positioner, the cutter feed conveyor and the portion cutter may be implemented as separate machines operationally connected with each other. In other embodiments, some or all of the above components may be implemented as a partly or completely integrated machine that includes some or all of the above components, e.g. in a single housing or support structure.

It should be emphasized that the term “comprises/comprising” when used in this specification is taken to specify the presence of stated features, elements, steps or components but does not preclude the presence or addition of one or more other features, elements, steps, components or groups thereof. The indefinite article “a” or “an” does not exclude a plurality.

Generally, various aspects disclosed herein may be summarized as follows:

Embodiment 1: An apparatus for portion cutting of meat items, wherein the apparatus comprises:
a first shape sensor for measuring a shape of a meat item to be cut into portions, the shape defining a reference direction,
a cutter for cutting the meat item into portions,
a cutter feed conveyor for conveying the meat item to the cutter, the cutter feed conveyor defining a feed direction,
a control module configured to compute, based on the measured shape and based on one or more predetermined cut criteria, a target orientation associated with the meat item, the target orientation being indicative of a target angle between the reference direction and the feed direction and
an item positioner configured to position the meat item on the cutter feed conveyor at the computed target orientation.

Embodiment 2: The apparatus according to embodiment 1, wherein the reference direction is an axis of minimum moment of inertia associated with the measured shape.

Embodiment 3: The apparatus according to any one of the preceding embodiments, wherein the meat item is a chiral item having a handedness, wherein the control module is configured to identify, in particular based on the measured shape, the handedness of the meat item and to compute the target orientation further based on the identified handedness.

Embodiment 4: The apparatus according to embodiment 3, wherein the control module is configured to identify the handedness of the meat item based on the measured shape and on a visually identifiable anatomical feature of the meat item.

Embodiment 5: The apparatus according to any one of the preceding embodiments, wherein the control module is configured to identify, based on the measured shape, a predominant muscle fiber direction of the meat item and to compute the target orientation further based on the identified muscle fiber direction.

Embodiment 6: The apparatus according to any one of the preceding embodiments, wherein the item positioner is configured to position the meat item at a placement location on the cutter feed conveyor, wherein the cutter defines a cutting location relative to the cutter feed conveyor, and where the cutter feed conveyor is uninterrupted between the placement location and the cutting location.

Embodiment 7: The apparatus according to any one of the preceding embodiments, further comprising a second shape sensor configured to measure the shape of the meat item after having been placed on the cutter feed conveyor by the item positioner.

Embodiment 8: The apparatus according to any one of the preceding embodiments, comprising a cutter control module, configured to control the cutter to cut the meat item based on the measured shape, measured by the first shape sensor, and/or based on a measured shape of the meat item measured by a second shape sensor after the meat item has been placed by the item positioner on the cutter feed conveyor.

Embodiment 9: The apparatus according to any one of the preceding embodiments; wherein the control module is further configured to receive feedback input from the cutter and/or from a second shape sensor, the second shape sensor being configured to measure the shape of the meat item after the meat item has been placed by the item positioner on the cutter feed conveyor, and to compute the target orientation associated with a current meat item further based on the received feedback input from the cutter and/or the second shape sensor, the feedback input being associated with one or more previously processed meat items.

Embodiment 10: The apparatus according to any one of the preceding embodiments; wherein the cutter is configured to cut the meat item along a first cutting plane relative to the meat item.

Embodiment 11: The apparatus according to embodiment 10, wherein the apparatus further comprises a further cutting device positioned upstream from the first shape sensor and configured to cut the meat item along a second cutting plane, different from the first cutting plane.

Embodiment 12: The apparatus according to embodiment 10 or 11, wherein the apparatus further comprises a further cutting device positioned downstream from the cutter and configured to cut one or more of the cut portions along a second cutting plane, different from the first cutting plane.

Embodiment 13: The apparatus according to any one of the preceding embodiments; wherein the item positioner comprises a pick-and-place robot.

Embodiment 14: The apparatus according to embodiment 13; comprising a feed conveyor configured for feeding the meat item to the pick-and-place robot; wherein the pick-and-place robot is configured to pick the meat item from the feed conveyor and to place the meat item onto the cutter feed conveyor.

Embodiment 15: The apparatus according to embodiment 14; wherein the cutter feed conveyor and the feed conveyor define a reject gap between them, the reject gap being configured for receiving any meat item being conveyed by the feed conveyor and not picked up by the pick-and-place robot.

Embodiment 16: The apparatus according to any of the preceding embodiments, further comprising an item quality sensor configured to detect one or more quality parameters of the meat item.

Embodiment 17: The apparatus according to any one of the preceding embodiments, wherein the one or more predetermined cut criteria define one or more target ranges of the size and/or shape of the cut portions of meat.

Embodiment 18: The apparatus according to any one of the preceding embodiments, wherein the one or more predetermined cut criteria comprise an optimization criterion to maximize a degree of compliance of the cut portions of meat with one or more target properties or with target ranges of one or more properties of the cut portions, in particular to maximize a degree of compliance of the cut portions with one or more target sizes and/or target shapes, such as to maximize an amount of cut portions having a size and/or shape within the one or more target ranges.

Embodiment 19: The apparatus according to any one of the preceding embodiments, wherein the cut portions of meat are strips of meat and wherein the one or more predetermined cut criteria comprise an optimization criterion to maximize a number of cut strips of meat having a length within one or more target ranges.

Embodiment 20: The apparatus according to any one of the preceding embodiments, wherein the cut portions of meat include one or more burger filling portions and wherein the one or more predetermined cut criteria comprise an optimization criterion to obtain a burger filling portion having a weight and shape at least approximating a desired target weight and target shape, respectively.

Embodiment 21: The apparatus according to any one of the preceding embodiments, wherein the measured shape is indicative of a contour of a view of the meat item from a viewing direction.

Embodiment 22: A computer-implemented method for controlling portion cutting of meat items, wherein the method comprises:
receiving shape data indicative of a measured shape of a meat item to be cut into portions, the shape defining a reference direction,
computing, based on the measured shape and based on one or more predetermined cut criteria, a target orientation associated with the meat item, the target orientation being indicative of a target angle between the reference direction and a feed direction for feeding the meat item to a cutter, and
outputting the target orientation for controlling an item positioner to position the meat item at the computed target orientation.

Embodiment 23: A computer program comprising program code configured to cause, when executed by a data processing system, the data processing system to perform the acts of the method according to embodiment 22.

Embodiment 24: A data processing system configured to perform the acts of the method according to embodiment 22.

Embodiment 25: A method for portion cutting of meat items, wherein the method comprises:
measuring a shape of a meat item to be cut into portions, the shape defining a reference direction,
computing, based on the measured shape and based on one or more predetermined cut criteria, a target orientation associated with the meat item, the target orientation being indicative of a target angle between the reference direction and a feed direction for transporting the meat item to a cutter;
advancing the meat item along the feed direction with the meat item oriented at the computed target orientation relative to the feed direction,
cutting the meat item into portions.

While embodiments of the invention have been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

1.-25. (canceled)

26. An apparatus for portion cutting of meat items, wherein the apparatus comprises:
a first shape sensor for measuring the shape of a meat item to be cut into portions, the shape defining a reference direction,
a cutter for cutting the meat item into portions,
a cutter feed conveyor for conveying the meat item to the cutter, the cutter feed conveyor defining a feed direction,
a control module configured to compute, based on the measured shape and based on one or more predetermined cut criteria, a target orientation associated with the meat item, the target orientation being indicative of a target angle between the reference direction and the feed direction and
an item positioner configured to position the meat item on the cutter feed conveyor at the computed target orientation.

27. The apparatus according to claim 26, wherein the reference direction is an axis of minimum moment of inertia associated with the measured shape.

28. The apparatus according to claim 26, wherein the meat item is a chiral item having a handedness,
wherein the control module is configured to identify, in particular based on the measured shape and/or on a visually identifiable anatomical feature of the meat item, the handedness of the meat item and to compute the target orientation further based on the identified handedness.

29. The apparatus according to claim 28, wherein the control module is configured to identify the handedness of the meat item based on the measured shape and on a visually identifiable anatomical feature of the meat item.

30. The apparatus according to claim 26, wherein the control module is configured to identify, based on the measured shape, a predominant muscle fiber direction of the meat item and to compute the target orientation further based on the identified muscle fiber direction.

31. The apparatus according to claim 26, wherein the item positioner is configured to position the meat item at a placement location on the cutter feed conveyor,
wherein the cutter defines a cutting location relative to the cutter feed conveyor, and where the cutter feed conveyor is uninterrupted between the placement location and the cutting location.

32. The apparatus according to claim 26, further comprising a second shape sensor configured to measure the shape of the meat item after having been placed on the cutter feed conveyor by the item positioner.

33. The apparatus according to claim 26, comprising a cutter control module, configured to control the cutter to cut the meat item based on the measured shape, measured by the first shape sensor, and/or based on a measured shape of the meat item measured by a second shape sensor after the meat item has been placed by the item positioner on the cutter feed conveyor.

34. The apparatus according to claim 26, wherein the control module is further configured to receive feedback input from the cutter and/or from a second shape sensor, the second shape sensor being configured to measure the shape of the meat item after the meat item has been placed by the item positioner on the cutter feed conveyor, and to compute the target orientation associated with a current meat item further based on the received feedback input from the cutter and/or the second shape sensor, the feedback input being associated with one or more previously processed meat items.

35. The apparatus according to claim 26, wherein the cutter is configured to cut the meat item along a first cutting plane relative to the meat item.

36. The apparatus according to claim 35, wherein the apparatus further comprises a further cutting device positioned upstream from the first shape sensor and configured to cut the meat item along a second cutting plane, different from the first cutting plane.

37. The apparatus according to claim 35, wherein the apparatus further comprises a further cutting device positioned downstream from the cutter and configured to cut one or more of the cut portions along a second cutting plane, different from the first cutting plane.

38. The apparatus according to claim 26, wherein the item positioner comprises a pick-and-place robot.

39. The apparatus according to claim 38, comprising a feed conveyor configured for feeding the meat item to the pick-and-place robot;
wherein the pick-and-place robot is configured to pick the meat item from the feed conveyor and to place the meat item onto the cutter feed conveyor.

40. The apparatus according to claim 39, wherein the cutter feed conveyor and the feed conveyor define a reject gap between them, the reject gap being configured for receiving any meat item being conveyed by the feed conveyor and not picked up by the pick-and-place robot.

41. The apparatus according to claim 26, further comprises an item quality sensor configured to detect one or more quality parameters of the meat item.

42. The apparatus according to claim 26, wherein the one or more predetermined cut criteria define one or more target ranges of the size and/or shape of the cut portions of meat.

43. The apparatus according to claim 26, wherein the one or more predetermined cut criteria comprise an optimization criterion to maximize a degree of compliance of the cut portions of meat with one or more target properties or with target ranges of one or more properties of the cut portions, in particular to maximize a degree of compliance of the cut portions with one or more target sizes and/or target shapes, such as to maximize an amount of cut portions having a size and/or shape within the one or more target ranges.

44. A computer-implemented method for controlling portion cutting of meat items, wherein the method comprises:
receiving shape data indicative of a measured shape of a meat item to be cut into portions, the shape defining a reference direction,
computing, based on the measured shape and based on one or more predetermined cut criteria, a target orientation associated with the meat item, the target orientation being indicative of a target angle between the reference direction and a feed direction for feeding the meat item to a cutter, and
outputting the target orientation for controlling an item positioner to position the meat item at the computed target orientation.

45. A method for portion cutting of meat items, wherein the method comprises:
measuring the shape of a meat item to be cut into portions, the shape defining a reference direction,
computing, based on the measured shape and based on one or more predetermined cut criteria, a target orientation associated with the meat item, the target orientation being indicative of a target angle between the reference direction and a feed direction for transporting the meat item to a cutter;
advancing the meat item along the feed direction with the meat item oriented at the computed target orientation relative to the feed direction,
cutting the meat item into portions.
